(19) United States
(12) Patent Application Publication
(10) Pub. No.: US 2009/0052881 A1
(43) Pub. Date: Feb. 26, 2009

(54) METHOD FOR CONTROLLING DIRECTION CONTROLLABLE FLASH UNIT AND IMAGING SYSTEM USING SAME

(75) Inventor: CHANG-CHIANG LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/126,982

(22) Filed: May 26, 2008

(30) Foreign Application Priority Data
Aug. 23, 2007 (CN) 200710201445.6

(51) Int. Cl. G03B 15/06; H04N 5/222

(52) U.S. Cl. 396/175; 348/371; 348/E05.022

(57) ABSTRACT

An exemplary method for controlling a direction controllable flash unit of an imaging system is disclosed. The method includes: focusing the imaging system on a primary object; capturing an image having a focal point centered on a portion corresponding to the focused primary object; obtaining a number of position values of the focal point; calculating a number of orientation angle values using the obtained position values; orienting the direction controllable flash unit according to the calculated orientation angle values so as to direct the flash emitted from the direction controllable flash unit to the primary object.

### BACKGROUND

1. Technical Field

The invention relates to flash photography systems and, particularly, to a method for controlling a direction controllable flash unit of an imaging system and the imaging system.

2. Description of Related Art

Most cameras directs the flash emitted from a flash unit thereof only to a portion of an object corresponding to the central portion of an image. Because it is generally assumed that the central portion of the viewing area of the camera is where the primary object of interest is located, flash units are configured to focus or concentrate their flash on the central portion. Recently, camera manufacturers have developed new models with the capability of focusing on any area of an object, either automatically or manually. However, this may cause the flash unit not to properly illuminate the focused portion of the primary object when the focal point is away from the central portion of the object.

Therefore, it is desirable to provide a method for controlling a direction controllable flash unit of an imaging system and an imaging system, which can overcome the above-mentioned problem.

### SUMMARY

In a present embodiment, a method for controlling a direction controllable flash unit of an imaging system is disclosed. The method includes: focusing the imaging system on a primary subject of interest; capturing an image having a focal point centered on a portion corresponding to the primary subject; obtaining a number of position values of the focal point; calculating a number of orientation angle values using the obtained position values; orienting the direction controllable flash unit according to the calculated orientation angle values so as to direct the flash emitted from the direction controllable flash unit to the primary subject of interest.

### BRIEF DESCRIPTION OF THE DRAWINGS

Many aspects of the present imaging system and method should be better understood with reference to the following drawings. The components in the drawings are not necessarily drawn to scale, the emphasis instead being placed upon clearly illustrating the principles of the present imaging system and method. Moreover, in the drawings, like reference numerals designate corresponding parts throughout the several views.

FIG. 1 is a functional diagram of an imaging system including a direction controllable flash unit, according to an exemplary embodiment.

FIG. 2 is a planar, schematic view of the direction controllable flash unit of FIG. 1.

FIG. 3 is a flow chart of a method for controlling a direction controllable flash unit of an imaging system, according to the exemplary embodiment described in FIG. 1.

### DETAILED DESCRIPTION OF THE EMBODIMENTS

Embodiments of the present imaging system and method will now be described in detail with reference to the accompanying drawings.

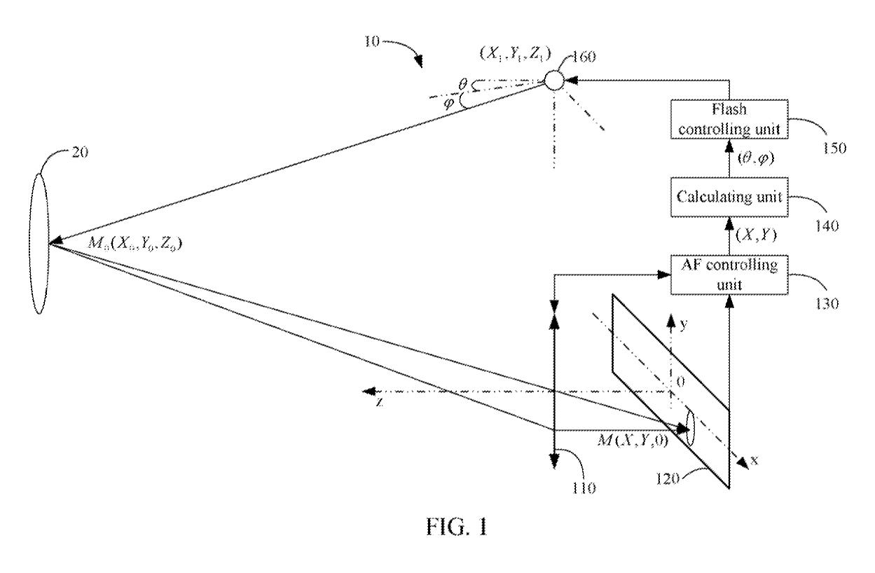

Referring to FIG. 1, an imaging system 10 such as a digital still camera or video camcorder, according to an exemplary embodiment, includes a lens module 110, an image sensor 120, an auto focus (AF) controlling unit 130, a calculating unit 140, a flash controlling unit 150, and a direction controllable flash unit 160. The lens module 110 is configured for working with the image sensor 120 to form an image. The AF controlling unit 130 is configured for controlling the lens module 110 to focus on a portion of the image. The calculating unit 140 is configured for obtaining position values (e.g., coordinates ‘X’, ‘Y’ in a coordinate system ‘0xyz’ in FIG. 1) of a focal point ‘M’ centered on a portion of the image corresponding to the primary object 20 from the AF unit 130, and calculating orientation angle values (e.g. θ angle defined in the 0xz plane, and φ angle defined in the 0yz plane, see FIG. 1) using the obtained position values. The flash controlling unit 150 is configured for orienting the direction controllable flash unit 160 according to the calculated orientation angle values so as to direct the flash emitted from the direction controllable flash unit 160 to the proper portion of the object 20, i.e. turning θ degrees in the 0xz plane, and φ degrees in the 0yz plane.

The lens module 110, the image sensor 120, and the AF controlling unit 130 constitute an AF sub-system of the imaging system 10, and many techniques such as phase detection or contrast measurement can be used in this AF sub-system. This AF sub-system allows the user to emphasize any area of the image by placing the focal point M on the center of that area selectively designating the primary object 20. In particular, this can be carried out automatically or manually. The manual AF mode allows the user to select one predetermined area, e.g., center, top, top left, left, top right, right, bottom, bottom left, or bottom right as the location of the primary object 20, and the focal point M is then centered on the selected predetermined area. The auto AF mode can automatically determine which portion of the image should be emphasized using image processing technique, e.g., human face detection (assuming the face to be the primary object 20), and the focal point M is centered on the determined portion.

Understandably, regardless of which mode is chosen, the position values of the focal point M (e.g., coordinates X, Y in the 0xyz coordinate system in FIG. 1) are generated by the AF controlling unit 130, and are configured to bring the captured image into focus. Thereby, position values (e.g., coordinates ‘X₀’, ‘Y₀’, ‘Z₀’ in the 0xyz coordinate system in FIG. 1) of a point M₀ of the primary object 20 corresponding to the focal point M can be calculated too. Additionally, position values (e.g., coordinates ‘X₁’, ‘Y₁’, ‘Z₁’ in the 0xyz coordinate system in FIG. 1) of the direction controllable flash unit 160 can be preset (e.g., recorded into the calculating unit 140) by the manufacturer. Therefore, once the position values of the focal point M are obtained, the calculating unit 140 can calculate the orientation angle values.

Various components of the imaging system 10 such as the AF controlling unit 130, the calculating unit 140, and the flash controlling unit 150 can be integrated into a single control unit. For example, such components can be software programs executed by hardware such as an FPGA or an ASIC to acquire the above-mentioned functionality of the components.

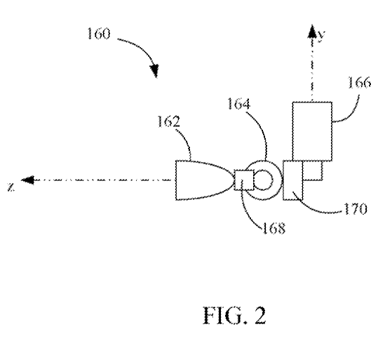

Referring to FIG. 2, the direction controllable flash unit 160 of this embodiment includes a flash unit 162, a first motor 164, a second motor 166, a first base 168, and a second base 170. The first motor 164 is coupled to the flash unit 162 via the first base 168, and is configured for driving the flash unit 162 to turn in a first direction (e.g., turning an angle θ in the 0xz plane of the 0xyz coordinate system of FIG. 1). The second motor 166 is coupled to the first motor 164 via a second base 170, and is configured to driving the flash unit 162 to turn in a second direction (e.g., turning an angle φ in the 0yz plane of the 0xyz coordinate system of FIG. 1, which is perpendicular to the 0xz plane).

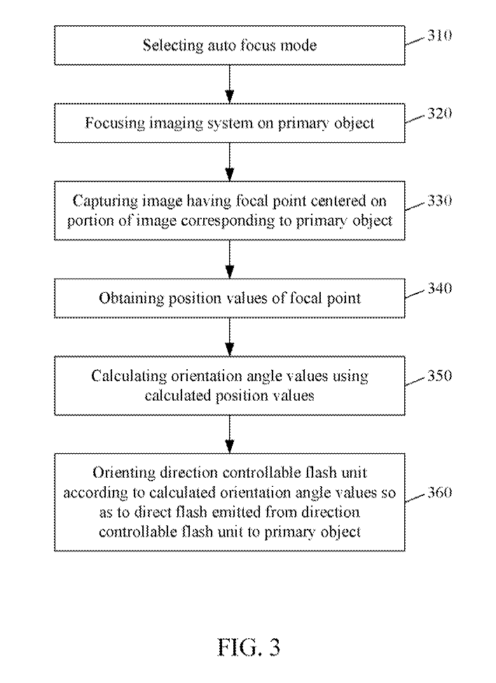

Referring to FIG. 3, a method for controlling a direction controllable flash unit of an imaging system includes the following steps 310˜360.

Step 310: selecting an AF mode. This can be done by a user. For example, the method is applied to the imaging system 10 to take a portrait image, and, during previewing, the auto AF mode is chosen by the user in this step.

Step 320: focusing the imaging system 10 on the primary object 20. In this embodiment, the AF controlling unit 130 controls the lens module 110 to focus light on the primary object 20. If, for example, the primary object is a human face, the AF controlling unit 130 uses human face detection to detect which area to be emphasized, and uses contrast measurements to bring that area into focus. In general, this step is carried out when a shutter bottom of the image system 10 is half-depressed, which is for triggering a focus function thereof.

Step 330: capturing an image having a focal point centered on a portion corresponding to the primary object 20. In detail, the lens module 110 exposes the image sensor 120 and thereby forms the image thereon. This step is typically carried out during previewing, and the captured image is a preview image.

Step 340: obtaining position values of the focal point. This can be carried out by the calculating unit 140. In detail, the position values are the three coordinates X, Y, Z (Z=0) in the 0xyz coordinate system (see FIG. 1).

Step 350: calculating orientation angle values using the obtained position values. This can be carried out by the calculating unit 140. As mentioned earlier, the orientation angle values can be two angle values θ,φ and can be calculated after the position values of the focal point have been determined.

Step 360: orienting the direction controllable flash unit according to the calculated orientation angle value so as to direct the flash emitted from the direction controllable flash unit to the primary object. In this embodiment, the flash controlling unit 150 controls the direction controllable flash unit 160 turn θ degrees in the 0xz plane, and φ degrees in the 0yz plane.

After the steps 310-360 have been done, the user can fully depress the shutter bottom of the image system 10 to take a final correctly-exposed image.

The method and imaging system vary the orientation of the direction controllable flash unit according to the position of the focal point on the primary object, and thereby are capable of accurately illuminating the foreground.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A method for controlling a direction controllable flash unit of an imaging system, comprising:
focusing the imaging system on a primary object;
capturing an image having a focal point centered on a portion corresponding to the primary object;
obtaining a plurality of position values of the focal point;
calculating a plurality of orientation angle values using the obtained position values; and
orienting the direction controllable flash unit according to the calculated orientation angle value so as to direct the flash emitted from the direction controllable flash unit to the primary object.

2. The method as claimed in claim 1, wherein the imaging system is focused on the object using a technique selected from the group consisting of phase detection and contrast measurement.

3. The method as claimed in claim 1, wherein the imaging system focuses using a mode selected from the group consisting of manual and auto, the manual mode being configured for focusing the imaging system with emphasis on an area selected by a user, the auto mode being configured for focusing the imaging system with emphasis on an area determined by the imaging system.

4. The method as claimed in claim 3, further comprising: selecting a mode.

5. The method as claimed in claim 1, wherein the position values are three coordinates in a predetermined coordinate system.

6. The imaging system as claimed in claim 1, wherein the orientation angle values are two angle values defined in two planes which are perpendicular to each other.

7. An imaging system comprising:
a lens module;
an image sensor;
an auto focus controlling unit capable of controlling the pickup lens module to focus light from a primary object onto the image sensor so as to form an image having a focal point centered on a portion corresponding to the primary object;
a calculating unit capable of obtaining a plurality of position values of the focal point and calculating a plurality of orientation angle values using the obtained position values of focal point;
a direction controllable flash unit; and
a flash controlling unit capable of orienting the direction controllable flash unit according to the calculated orientation angle values.

8. The imaging system as claimed in claim 7, wherein the auto focus controlling unit is configured for focusing the lens module using a technique selected from the group consisting of phase detection and contras measurement.

9. The imaging system as claimed in claim 7, wherein the auto focus controlling unit is configured for focusing the lens module with emphasis on an area of the image selected by a user.

10. The imaging system as claimed in claim 7, wherein the auto focus controlling unit is configured for focusing the lens module with emphasis on an area of the image that is automatically determined by the imaging system.

11. The imaging system as claimed in claim 10, wherein the auto focus controlling unit automatically determines the area to be emphasized using a face detection technique.

12. The imaging system as claimed in claim 7, wherein the position values are three coordinates in a predetermined coordinate system.

13. The imaging system as claimed in claim 7, wherein the orientation angle values are two angle values defined in two planes which are perpendicular to each other.

14. The imaging system as claimed in claim 7, wherein the direction controllable unit comprises:
a flash unit;
a first base;
a first motor coupled to the flash unit via the first base and configured for orienting the flash unit in a first plane;
a second base; and
a second motor for orienting the flash unit in a second plane that is perpendicular to the first plane.

15. The imaging system as claimed in claim 7, being selected from the group consisting of digital still camera and video camcorder.
